(19) United States
(12) Patent Application Publication
(10) Pub. No.: US 2015/0144556 A1
(43) Pub. Date: May 28, 2015

(54) ANTISCALANT COMPOUND AND METHODS OF MAKING AND USING THE SAME

(71) Applicants: KING ABDULAZIZ CITY FOR SCIENCE AND TECHNOLOGY, RIYADH (SA); KING FAHD UNIVERSITY OF PETROLEUM AND MENERALS, DHAHRAN (SA)

(72) Inventors: SHAIKH ASROF ALI, DHAHRAN (SA); IZZAT WAJIH KAZI, DHAHRAN (SA); FAIZUR RAHMAN, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MENERALS, DHAHRAN (SA)

(21) Appl. No.: 14/091,303

(22) Filed: Nov. 26, 2013

(51) Int. Cl. C02F 5/14; C08F 130/02; C02F 1/44

(52) U.S. Cl. CPC C02F 5/14; C02F 1/441; C08F 130/02; C02F 2305/04; C02F 2103/08
USPC 210/638; 525/369

(57) ABSTRACT

The antiscalant compound is a dianionic polyelectrolyte (DAPE), namely, poly[disodium 3-(N,N-diallylamino)propanephosphonate]. The cationic polyelectrolyte (CPE) polydiallyl(diethylphosphonato)propylammonium chloride is synthesized by cyclopolymerization of the monomer. The CPE contains a pendant having a three-carbon spacer separating the diethylphosphonate and NH⁺. Upon acidic hydrolysis of the phosphonate esters, the CPE was converted into a pH-responsive polyzwitterionic acid (PZA), poly[3-(N,N-diallylammonio)propanephosphonic acid], which was converted to DAPE poly[disodium 3-(N,N-diallylamino)propanephosphonate] and to a zwitterionic/anionic polyelectrolyte (ZAPE) poly[sodium 3-(N,N-diallylammonio)propanephosphonate]. The solution properties of the polymers were correlated to the structurally similar polyzwitterion (PZ) having monoethylphosphonate and NH⁺ groups. Evaluation of the antiscalant properties of the DAPE using concentrated brines revealed that the DAPE at a concentration of 10 ppm is very effective in inhibiting the formation of calcium sulfate scale, particularly in reverse osmosis plants.

### BACKGROUND OF THE INVENTION

1. Field of the Invention

The present invention relates to polyelectrolytes, and particularly to an antiscalant compound, namely the dianionic polyelectrolyte (DAPE) poly[disodium 3-(N,N-diallylamino)propanephosphonate], which may be used as an inhibitor of scale, such as CaSO₄, in desalination plants using reverse osmosis to produce potable water.

2. Description of the Related Art

Reverse osmosis (RO) is a water purification technology that uses a semipermeable membrane. This membrane-technology is not properly a filtration method. In RO, an applied pressure is used to overcome osmotic pressure, a colligative property that is driven by chemical potential, a thermodynamic parameter. RO can remove many types of molecules and ions from solutions, and is used in both industrial processes and in producing potable water. The result is that the solute is retained on the pressurized side of the membrane, and the pure solvent is allowed to pass to the other side. To be selective, this membrane should not allow large molecules or ions through the pores (holes), but should allow smaller components of the solution (such as the water solvent, for example) to pass freely. The RO process is commonly used in desalination plants for the purification of brackish water and seawater. In the reverse osmosis desalination process, the feed water splits into product water and reject brine streams. The dissolved salts in the feed water are concentrated in the reject brine stream. If supersaturation occurs and their solubility limits are exceeded, precipitation or scaling will occur.

The deposits commonly encountered in the desalination process include mineral scales (e.g., CaCO₃, CaSO₄ and Mg(OH)₂), corrosion products, polymeric silica and suspended matter. The specific mechanism of inhibition of scaling is sequestration, or the capability of forming stable complexes with polyvalent cations. The antiscalant-treated solutions are stabilized via alteration in crystal morphology at the time of nucleation and subsequent inhibition in growth rate. Commonly used antiscalants are derived from three chemical families: condensed poly(phosphate)s, organophosphates, and polyelectrolytes. The anionic form of the antiscalants helps prevent scale formation by sequestering the cations.

Due to the extraordinary chelating properties of compounds containing aminomethylphosphonic acid groups in the molecule, it would be desirable to use such a compound for the synthesis of low molecular-weight chelating agents containing these functional groups, allowing for the formation of polymer-heavy metal ion complexes from wastewater. Further, present antiscalants typically have a relatively high phosphorous content, which is damaging to the environment. It would be further desirable to produce an effective antiscalant with a low phosphorous content.

Thus, an antiscalant compound solving the aforementioned problems is desired.

### SUMMARY OF THE INVENTION

The antiscalant compound is a dianionic polyelectrolyte (DAPE), namely, poly[disodium 3-(N,N-diallylamino)propanephosphonate]. Using the Butler's cyclopolymerization process, the cationic polyelectrolyte (CPE) polydiallyl(diethylphosphonato)propylammonium chloride is synthesized. The CPE contains a pendant having a three-carbon spacer separating the diethylphosphonate and NH⁺. Upon acidic hydrolysis of the phosphonate esters, the CPE was converted into a pH-responsive polyzwitterionic acid (PZA) PZA poly[3-(N,N-diallylammonio)propanephosphonic acid], which was converted to DAPE, poly[disodium 3-(N,N-diallylamino)propanephosphonate] and a zwitterionic/anionic polyelectrolyte (ZAPE), namely, poly[sodium 3-(N,N-diallylammonio)propanephosphonate]. The solution properties of the polymers were correlated to the structurally similar polyzwitterion (PZ) having monoethylphosphonate and NH⁺ groups. Evaluation of the antiscalant properties of the DAPE using concentrated brines revealed that the DAPE, at a concentration of 10 ppm, is very effective in inhibiting the formation of calcium sulfate scale, particularly in reverse osmosis plants.

These and other features of the present invention will become readily apparent upon further review of the following specification and drawings.

### BRIEF DESCRIPTION OF THE DRAWINGS

FIG. 1 is the ¹H NMR spectra for the antiscalant compound according to the present invention, namely, a dianionic polyelectrolyte (DAPE), as well as a cationic phosphonium monomer (CPM), viz., N,N-Diallyl-3-(diethylphosphonato)propylammonium chloride; an intermediate cationic polyelectrolyte (CPE), and a related zwitterionic/anionic polyelectrolyte (ZAPE).

FIG. 2 is the ¹³C NMR spectra for the compounds of FIG. 1.

FIG. 3 is a graph comparing the viscosity behavior of the CPE, DAPE and ZAPE of FIGS. 1 and 2 in salt-free water and in 0.1 N NaCl, respectively, at 30° C.

FIG. 4 is a graph comparing the viscosity behavior of the DAPE and ZAPE of FIGS. 1 and 2 with a polyzwitterion (PZ) in salt-free water and 0.1 N NaCl, respectively, and with an anionic polyelectrolyte (APE), at 30° C.

FIG. 5 is a graph comparing the viscosity behavior of the CPE, DAPE produced via the CPE, and DAPE produced via the PZ in salt-free water and 0.1 N NaCl, respectively, at 30° C.

FIG. 6 is a graph illustrating the precipitation behavior of a supersaturated solution of CaSO₄ in a 10 ppm solution of the antiscalant compound according to the present invention, compared against a control.

Similar reference characters denote corresponding features consistently throughout the attached drawings.

### DETAILED DESCRIPTION OF THE PREFERRED EMBODIMENTS

The antiscalant compound is a dianionic polyelectrolyte, (DAPE), or more particularly, poly[disodium 3-(N,N-diallylamino)propanephosphonate]. As will be described in detail below, using the Butler's cyclopolymerization process, the cationic polyelectrolyte (CPE) polydiallyl(diethylphosphonato)propylammonium chloride is synthesized. The CPE contains a pendant having a three-carbon spacer separating the diethylphosphonate and NH⁺. Upon acidic hydrolysis of the phosphonate esters, the CPE was converted into a pH-responsive polyzwitterionic acid (PZA), poly[3-(N,N-diallylammonio)propanephosphonic acid], which was converted to DAPE, namely, poly[disodium 3-(N,N-diallylamino)propanephosphonate], and a zwitterionic/anionic polyelectrolyte (ZAPE) poly[sodium 3-(N,N-diallylammonio)propanephosphonate]. The solution properties of the polymers were correlated to the structurally similar polyzwitterion (PZ) having monoethylphosphonate and NH⁺ groups. Evaluation of the antiscalant properties of the DAPE using concentrated brines revealed that the DAPE, at a concentration of 10 ppm, is very effective in inhibiting the formation of calcium sulfate scale, particularly in reverse osmosis plants.

In the following, elemental analysis was performed on a PerkinElmer® 2400 Series II CHNS/O Analyzer, manufactured by PerkinElmer®, Inc. of Waltham, Mass. Infrared (IR) spectra were recorded on a PerkinElmer® 16F PC FTIR spectrometer, manufactured by PerkinElmer®, Inc. of Waltham, Mass. The ³¹P, ¹³C, and ¹H nuclear magnetic resonance (NMR) spectra of the polymers were measured in CDCl₃ using tetramethylsilane (TMS) as an internal standard or D₂O (using an HOD signal at δ4.65 ppm and a dioxane ¹³C peak at 567.4 ppm as internal standards) on a JEOL® LA-500 spectrometer, manufactured by JEOL® Ltd. Corporation of Tokyo, Japan. ³¹P was referenced with 85% H₃PO₄ in DMSO. Viscosity measurements were made by an Ubbelohde viscometer (having a viscometer constant of 0.005718 cSt/s at all temperatures) using CO₂-free water under N₂ in order to avoid CO₂ absorption that may affect the viscosity data. Molecular weights of some synthesized polymers were determined by gel permeation chromatography (GPC) analysis using a Viscotek® GPCmax VE 2001, manufactured by Malvern Instruments Incorporated of Westborough, Mass. The system was calibrated with nine polyethylene oxide monodispersed standards at 30° C. using two Viscotek® columns (series G5000 and G6000). A PerkinElmer® AAnalyist-100 atomic absorption spectrometer, manufactured by PerkinElmer®, Inc. of Waltham, Mass., was used to determine the concentration of metal ions in evaluating the effectiveness of the antiscalant. For the determination of molecular weights, the dianionic polyelectrolyte, as will be described in detail below, which is derived from the cationic polyelectrolyte (CPE) polydiallyl(diethylphosphonato)propylammonium chloride and a polyzwitterion, were analyzed using an aqueous solution of 0.1 N NaNO₃ as the eluent. Refractive Index and viscometer detectors were used to determine molar mass of the polymers. Ammonium persulfate, t-butylhydroperoxide (70% aqueous solution), anhydrous CaCl₂, Na₂SO₄, 1,3-dibromopropane, triethyl phosphite, and diallyl amine from Fluka Chemie AG (Buchs, Switzerland) were used as received. For dialysis, a Spectra/Por membrane with a molecular weight cut-off (MWCO) value of 6000-8000 was purchased from Spectrum Laboratories, Inc. All glassware was cleaned with deionized water. N,N-Diallyl-3-(diethylphosphonato)propylamine was prepared by reacting diallylamine and 1-Bromo-3-(diethylphosphonato)propane.

In order to produce pH-responsive polymers for use as antiscalants, the antiscalant compound is directed towards the synthesis and cyclopolymerization of the cationic phosphonium monomer N,N-Diallyl-3-(diethylphosphonato)propylammonium chloride to a cationic polyelectrolyte (CPE), which is then converted to a pH-responsive polyzwitterion-acid (PZA), a dianionic polyelectrolyte (DAPE), and a zwitterionic/anionic polyelectrolyte (ZAPE). The polymerization of a zwitterionic monomer to polyzwitterion (PZ) and its conversion to an anionic polyelectrolyte (APE), PZA, DAPE, and ZAPE allows for the correlation of solution properties with the charge types and densities on the polymer backbone.

In order to produce the initial cationic phosphonium monomer, N,N-diallyl-3-(diethylphosphonato)propylammonium chloride, an ice-cooled, stirred solution of N,N-diallyl-3-(diethylphosphonato)propylamine (41.3 g, 0.15 mol) in diethyl ether (300 cm³) was prepared. Moisture-free HCl was bubbled into the solution until the supernatant ether layer became clear and further production of a milky solution seized. The separated chloride salt was washed several times with ether to obtain N,N-diallyl-3-(diethylphosphonato)propylammonium chloride as a viscous liquid, which was then dried under vacuum at 40° C. to a constant weight (45.2 g, 97%). The viscous liquid was solidified inside a freezer. An analytical sample was prepared by crystallizing the N,N-diallyl-3-(diethylphosphonato)propylammonium chloride from an acetone/ether/methanol mixture. The highly hygroscopic salt gave an approximate elemental analysis as follows: C, 49.6; H, 8.97; N, 4.3. C₁₃H₂₇ClNO₃P requires C, 50.08; H, 8.73; N, 4.49%; νₘₐₓ (KBr) 3435, 2985, 2930, 2630, 2639, 1646, 1457, 1218, 1163, 1025, 963 and 768 cm⁻¹; δ_{H} (D₂O) 1.21 (6H, t, J 7.0 Hz), 1.89 (4H, m), 3.14 (2H, m), 3.69 (4H, m), 4.03 (4H, m), 5.51 (4H, m), 5.82 (2H, m); δ_{C} (125 MHz, D₂O): 16.49 (s, 2C, Me), 17.74 (s, 1C, PCH₂CH₂), 21.84 (d, 1C, d, PCH₂, ¹J(PC) 140 Hz), 52.30 (1C, d, PCH₂CH₂CH₂, ³J(PC) 17.5 Hz), 55.80 (s, 2C, ═CH—CH₂), 64.37 (d, 2C, OCH₂CH₃, ²J(PC) 7.2 Hz), 126.22 (s, 2C, =CH), 127.61 (s, 2C, CH₂=); δ_{P} (202 MHz, D₂O): 31.40 (m, 1P). ¹³C spectral assignments were supported by DEPT 135 NMR analysis.

For the polymerization of the cationic monomer, N,N-Diallyl-3-(diethylphosphonato)propylammonium chloride, both an ammonium persulfate (APS) initiator and a tert-butyl hydroperoxide (TBHP) were used. A solution of the N,N-diallyl-3-(diethylphosphonato)propylammonium chloride monomer in deionized water was placed in a 10 cm³ round bottomed flask purged with N₂. For APS, 400 mg. of the APS initiator was added to the solution. For TBHP, 270 mg. of the TBHP initiator was added to the solution. The mixture was stirred in the closed flask at 85° C. for 48 hours for both initiators. The transparent reaction mixture was dialyzed against deionized water for 24 hours. The resultant polymer solution of cationic polyelectrolyte (CPE), namely, polydiallyl(diethylphosphonato)propylammonium chloride was then freeze-dried. The onset of thermal decomposition (closed capillary) yielded the following results: 300-310° C. (decomposed, turned black); C, 49.8; H, 8.8; N, 4.4. C₁₃H₂₇ClNO₃P requires C, 50.08; H, 8.73; N, 4.49%; νₘₐₓ (KBr) 3400 (very broad almost engulfing the CH stretching vibrations), 2989, 2945, 1652, 1461, 1398, 1219, 1127, 1025, 968, 794, 705, 619, and 542 cm⁻¹; δ_{P} (202 MHz, D₂O): 33.84 (s, major) and 26.09 (s, minor) in a 75:25 ratio.

In order to perform the acid hydrolysis of the cationic polyelectrolyte (CPE) polydiallyl(diethylphosphonato)propylammonium chloride to obtain the polyzwitterion acid (PZA), poly[3-(N,N-diallylammonio)propanephosphonic acid, a solution of the cationic polyelectrolyte (CPE) polydiallyl(diethylphosphonato)propylammonium chloride was prepared (using TBHP as the initiator) (3.22 g, 10.3 mmol) in HCl (25 cm³) and water (20 cm³), which was then hydrolyzed in a closed vessel at 90° C. for 48 hours. The homogeneous mixture was cooled to room temperature and dialyzed against deionized water for 48 hours. Some polymer settled on the bottom of the dialysis bag. The whole mixture was then freeze-dried to obtain the PZA poly[3-(N,N-diallylammonio)propanephosphonic acid] as a creamy white powder (2.12 g, 94%). The onset of thermal decomposition (closed capillary) yielded the results: 310-320° C. (dec, turned light brown). Further analysis yielded: C, 49.0; H, 8.4; N, 6.2%. C₉H₁₈NO₃P requires C, 49.31; H, 8.28; N, 6.39%; νₘₐₓ (KBr) 3450, 2952, 2730, 1653, 1463, 1144, 1053, 907, 768, 709, and 543 cm⁻¹.

Basification of the PZA, poly[3-(N,N-diallylammonio)propanephosphonic acid], to both a dianionic polyelectrolyte (DAPE) and a zwitterionic anionic polyelectrolyte (ZAPE) was performed. For basification of the PZA to DAPE, a mixture of the PZA poly[3-(N,N-diallylammonio)propanephosphonic acid] (0.876 g, 4.0 mmol) in water (5.0 cm³) was neutralized with 1.0 N NaOH (8.0 cm³, 8.0 mmol) (2 equivalents of sodium hydroxide). After the mixture became homogeneous, the solution was freeze-dried to obtain the dianionic polyelectrolyte (DAPE) poly[disodium 3-(N,N-diallylamino)propanephosphonate] as a creamy white powder (1.02 g, 97%). The onset of thermal decomposition (closed capillary): above 300° C. (turned brown), did not melt even at 370° C.; C, 40.8; H, 6.4; N, 5.1. C₉H₁₆NNa₂O₃P requires C, 41.07; H, 6.13; N, 5.32%; νₘₐₓ (KBr) 3475 (very broad engulfing the CH stretching vibrations), 2920, 2820, 1660, 1451, 1390, 1306, 1222, 1060, 973, 783, and 613 cm⁻¹; δ_{P} (202 MHz, D₂O) 22.60 (s, 1P).

For basification of the PZA to ZAPE, a mixture of the PZA poly[3-(N,N-diallylammonio)propanephosphonic acid] (0.876 g, 4.0 mmol) in water (8.0 cm³) was neutralized with 1.0 N NaOH (4.0 cm³, 4.0 mmol) (1 equivalent of sodium hydroxide). After the mixture became homogeneous, the solution was freeze-dried to obtain the ZAPE poly[sodium 3-(N,N-diallylammonio)propanephosphonate] as a creamy white powder (0.894 g, 93%). The onset of thermal decomposition (closed capillary): Neither change in color nor melted up to 330° C.; C, 44.5; H, 7.35; N, 5.6. C₉H₁₇NNaO₃P requires C, 44.82; H, 7.10; N, 5.81%; νₘₐₓ (KBr) 3790, 2962, 2929, 2852, 1458, 1413, 1381, 1060, 974, 715, and 559 cm⁻¹; δ_{P} (202 MHz, D₂O: 20.81 (s, 1P).

As an alternative method, the synthesis and polymerization of a zwitterionic monomer was used to convert the resultant polyzwitterion (PZ) to the above PZA, DAPE, ZAPE and an anionic polyelectrolyte (APE), the zwitterionic monomer was synthesized and polymerized to obtain the PZ using the procedure described in Ali, Shaikh A. et al., “Synthesis and Solution Properties of a pH-Responsive Cyclopolymer of Zwitterionic Ethyl 3-(N,N-diallylammonio)propanephosphonate,” Journal of Polymer Science Part A: Polymer Chemistry, 48(24), 5693-5703, 2010.

Specifically, a solution of the zwitterionic monomer ethyl 3-(N,N-diallylammonio) propanephosphonate (6.06 g, 24.3 mmol) in 0.5 N NaCl (2.02 g) was polymerized using initiator TBHP (125 mg) at 85° C. for 48 hours. The reaction mixture was dialyzed against deionized water for 48 hours to remove the unreacted monomer and NaCl. The polymer solution was then freeze-dried to obtain the polyzwitterion (PZ) with a 59% yield. The intrinsic viscosity [η] at 30° C. was determined to be 0.0988 dL/g in salt-free water. The PZ was hydrolyzed to obtain the PZA poly[3-(N,N-diallylammonio)propanephosphonic acid] (85%), which was then converted to the dianionic polyelectrolyte (DAPE) poly[disodium 3-(N,N-diallylamino)propanephosphonate] and the ZAPE poly[sodium 3-(N,N-diallylammonio)propanephosphonate] using the same procedures described above. Likewise, the PZ was converted to an anionic polyelectrolyte (APE) using 1 equivalent NaOH as described in the Ali et al. article.

In order to evaluate the antiscalants, analysis of feed water and reject brine from a reverse osmosis (RO) plant, located at King Fahd University of Petroleum and Minerals in Dhahran, Saudi Arabia, revealed a concentration of Ca²⁺ of 281.2 ppm in the brackish feed water and 867.7 ppm in the reject brine; the corresponding concentration of SO₄²⁻ in the feed water and reject brine was found to be 611 and 2,100 ppm, respectively. The composition of the above reject brine at 70% recovery is referred to as “1 CB” (concentrated brine) in the below. The evaluation of the present dianionic polyelectrolyte (DAPE) poly[disodium 3-(N,N-diallylamino)propanephosphonate] scale inhibitor was performed in a solution containing 2.3 times the concentration of Ca²⁺ and SO₄²⁻ than 1 CB, The 2.3 CB solutions were supersaturated with respect to CaSO₄.

Solutions containing Ca²⁺ and SO₄²⁻ ions equal to 4.6 times the concentrated brine (1 CB) were prepared by dissolving the calculated amount of CaCl₂ and Na₂SO₄, respectively, in deionized water. 4.6 CB calcium chloride solution (60 mL) at a dose level of 20 ppm DAPE was taken in a two-necked round bottom flask and heated to 50° C.±1° C. A preheated (50° C.) solution of 4.6 CB sodium sulfate (60 mL) was added quickly to the flask, the content of which was stirred at 300 rpm using a magnetic stir-bar. The resultant solution containing 10 ppm of DAPE thus became 2.3 CB, which is 2.3×866.7 mg/L; i.e., 1993 mg/L in Ca²⁺ and 2.3×2100 mg/L; i.e., 4830 mg/L in SO₄²⁻. 200 μL samples were taken at different time intervals through a 0.45 micron filter (millipore) to measure the Ca²⁺ ions remaining in the solution using an atomic absorption spectrometer, the results of which are given below in Table 1.

TABLE 1
Evaluation of CaSO₄ scale inhibition by DAPE

| | Solution^{a} with Inhibitor | Blank solution^{a} | Scale |
|---|---|---|---|
| Time (min) | Ca²⁺ (mg/L) | Ca²⁺ (mg/L) | Inhibition (%) |
| 0 | 1990 | 1990 | — |
| 6 | 1988 | 660 | 99.8 |
| 180 | 1984 | 640 | 99.6 |
| 420 | 1960 | 630 | 97.8 |
| 1800 | 1930 | 620 | 95.6 |

^{a}Both solutions contained Ca²⁺ and SO₄²⁻ at a concentration of 2.3 times the concentration of concentrated brine (CB), i.e., [Ca²⁺] = 1993 mg/L and [SO₄²⁻] = 4830 mg/L

The above polyphosphonates were found to be very stable and did not show any appreciable decomposition or color change up to 300° C. While the CPE, DAPE and ZAPE were found to be readily soluble in salt-free water, the PZA remained insoluble. A cloudy mixture of 3 wt % PZA in salt-free water became transparent in 0.03 M NaCl. The PZA was also found to be soluble in 0.1 N HCl. Although most polyzwitterions are found to be insoluble in water, the above PZ remained soluble both in salt-free and salt-added water as a result of the extensive hydration of the O⁻ and steric crowding exerted by OCH₂CH₃, which prevent effective zwitterionic interaction with the cationic nitrogens.

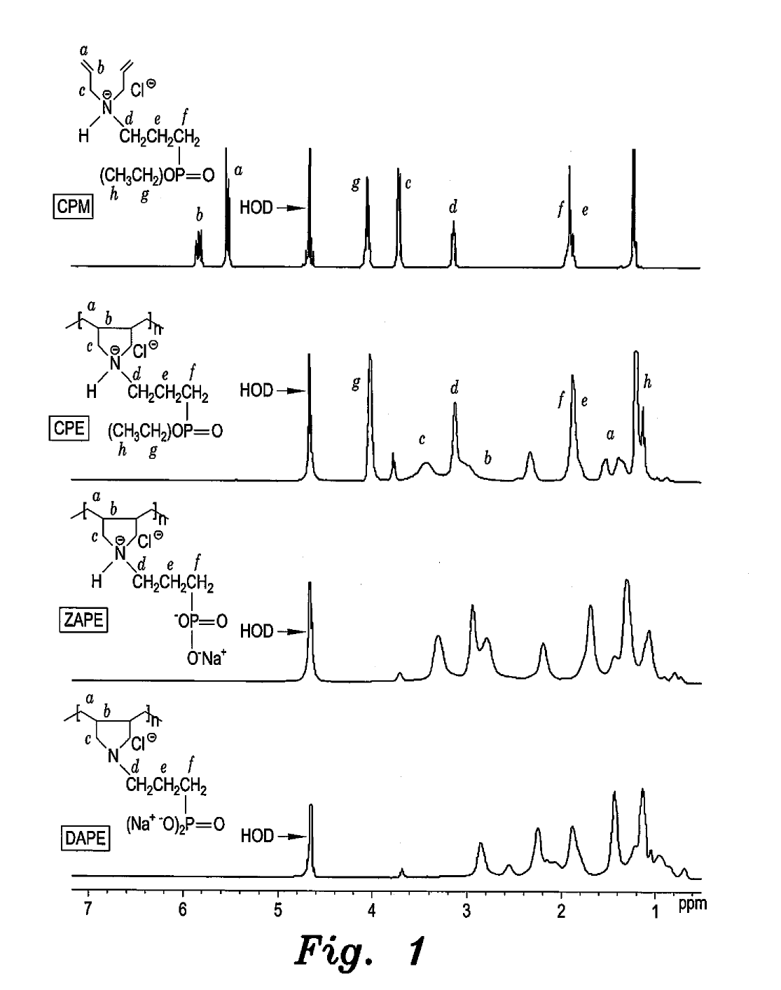

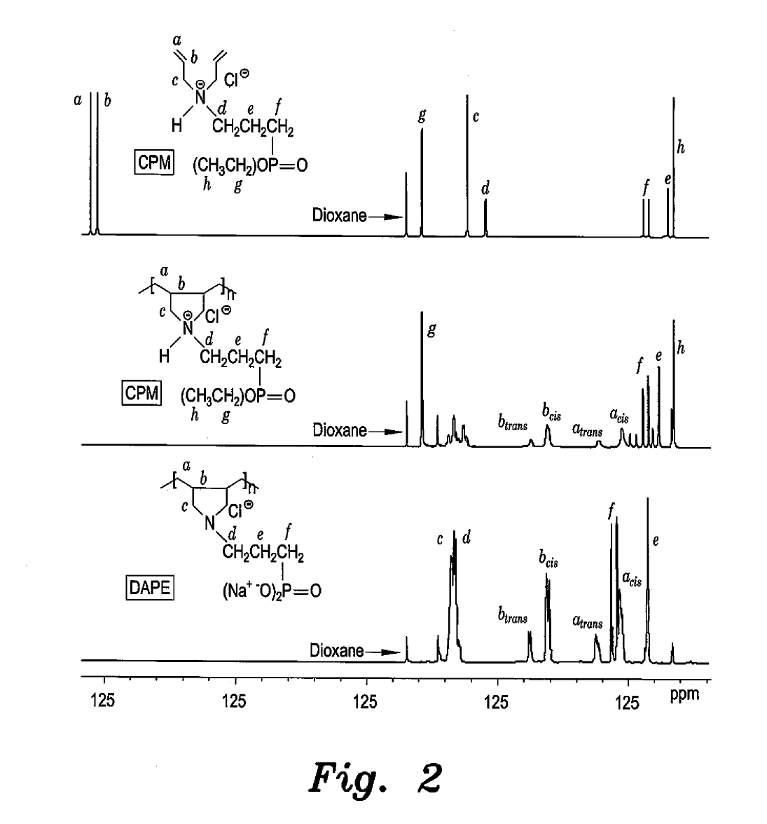

FIG. 1 shows the ¹H NMR spectra for the cationic phosphonium monomer (CPM) N,N-diallyl-3-(diethylphosphonato)propylammonium chloride, the CPE, DAPE and ZAPE in D₂O. With regard to the IR and NMR spectra, the strong absorptions at 1127 and 1025 cm⁻¹ in the IR spectrum of CPE are attributed to the stretching frequency of P═O and P—O—C, respectively. For the PZA, DAPE and ZAPE, the peaks at 1053, 1060, and 1060 cm⁻¹ are assigned to the stretching frequency of P═O. FIG. 2 shows the corresponding ¹³C NMR spectra of the monomer and polymers. The absence of any residual alkene proton or carbon signal in the spectra suggests the chain transfer process for the termination reaction.

The assignments of the ¹³C peaks are based on well-known results on quaternary ammonium salt monomers, which undergo cyclopolymerization to afford kinetically favorable five-membered ring structures, whose substituents at the ring carbons can either be in the symmetrical cis (major) or unsymmetrical trans (minor) dispositions. Integration of the signals yielded the cis/trans ratio of the ring substituents to be 75:25. Similar ratios are observed for many Butler's cyclopolymerization processes. ³¹P NMR signals for CPM, CPE, DAPE and ZAPE appeared at δ31.4, 33.8, 22.6 and 20.8 ppm, respectively. The upfield shift of P signal in DAPE and ZAPE is attributed to the higher electron density around P as a result of negatively charged oxygens.

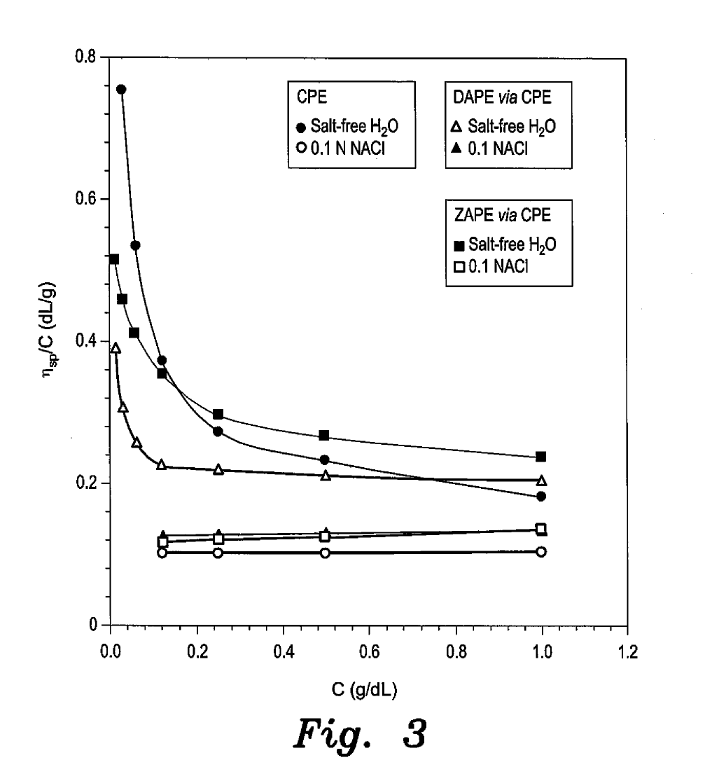

Viscosity data was evaluated by the Huggins equation. For the cyclopolymerization of the CPM to CPE using APS as the initiator, the intrinsic viscosity thereof was found to be 0.0934 dL/g. Using TBHP as the initiator yielded an intrinsic viscosity of 0.101 dL/g. The Huggins viscosity plots for CPE, DAPE and ZAPE (having identical degrees of polymerization) in salt-free water remain concave upwards, as expected for any polyelectrolyte, as shown in FIG. 3. In the lower concentration range, the sequence of decreasing reduced viscosity was found to be CPE>ZAPE>DAPE.

The lowest value for the Huggins constant k in the case of CPE in comparison to DAPE and ZAPE may be associated with an increased polymer-solvent interaction. The hydration shell of Na is generally fairly large. Thus, the distance of closest approach is not sufficient to effectively neutralize the charge on the pendant phosphonate anions in DAPE and ZAPE. However, Cl⁻ ions are very effective in shielding, thus minimizing the repulsion among positive nitrogens in CPE and ZAPE, which leads to lower hydrodynamic volumes and intrinsic viscosities [η].

The decrease and increase of intrinsic viscosity in the presence of an added salt is a demonstration of “polyelectrolyte” and “anti-polyelectrolyte” behavior of a polyelectrolyte (cationic or anionic) and a polyzwitterion, respectively. It should be noted that the intrinsic viscosity of ZAPE in 0.1 N, 0.5 N and 1.0 N NaCl remained almost unchanged (˜0.114 dL/g). ZAPE has dual groups of zwitterion and anion, and it is the anionic portion that dictates the viscosity plot in FIG. 3. The presence of NaCl leads to a contraction and expansion of the polymer chain of a polyelectrolyte and polyzwitterion, respectively. These opposite forces cancel the overall effect of NaCl in the solution, thereby leading to the unchanged intrinsic viscosity values for ZAPE in the presence of various concentrations of the salt.

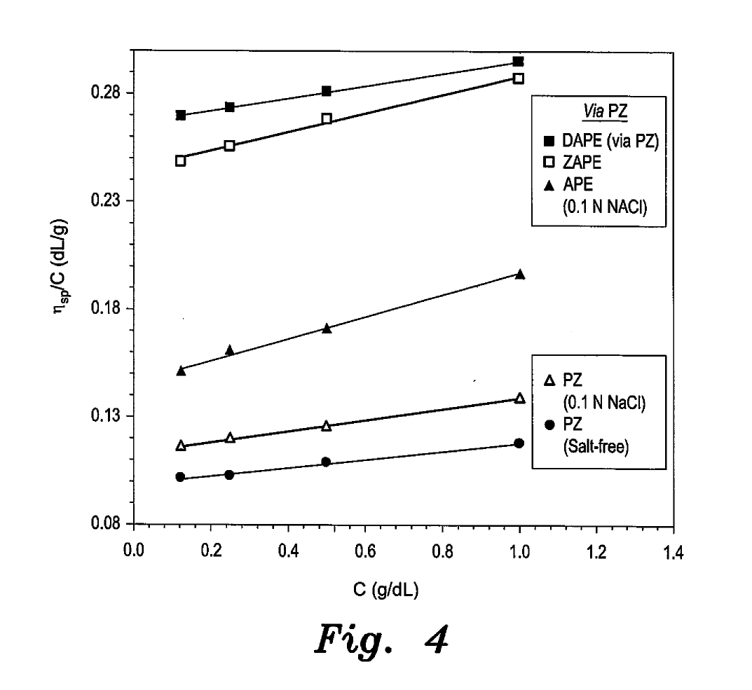

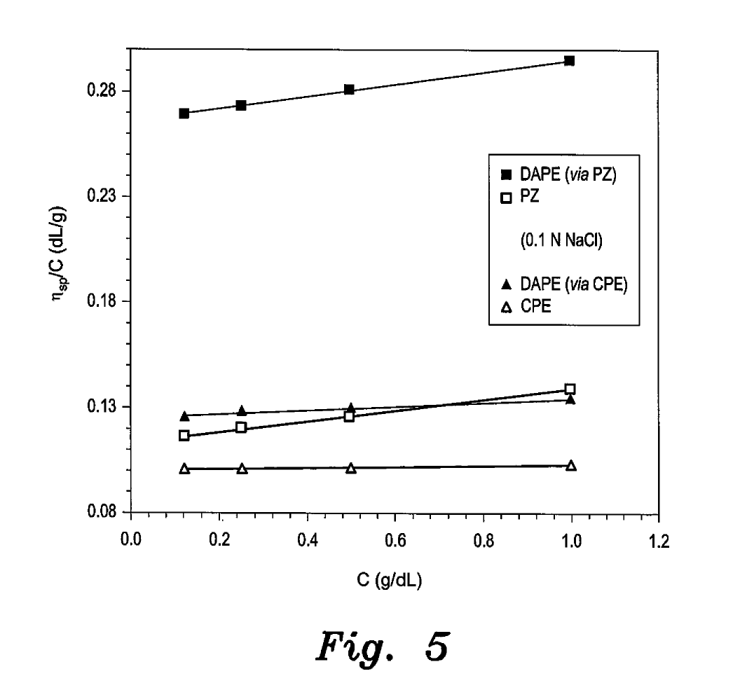

The viscosity plot for PZ in the absence or presence of added salt (NaCl) remains linear, as shown in FIG. 4. The intrinsic viscosities in salt-free and 0.1 N NaCl were found to be 0.0988 and 0.144 dL/g, respectively. An increase in the intrinsic viscosity in the presence of NaCl is a demonstration of the “anti-polyelectrolyte” behavior of the PZ. As noted above, the Cl⁻ ions shield the positive nitrogens more effectively than the shielding of phosphonate anions by the hydrated Na⁺ ions. As a result, the zwitterionic moiety is left with a net negative charge that leads to repulsion, and hence, expansion of the polymer chains. While CPE, ZAPE, and DAPE (derived from CPE) have intrinsic viscosity values of 0.101, 0.114, and 0.125 dL/g, respectively, the corresponding values for PZ, ZAPE, and DAPE (derived from PZ) are found to be 0.114, 0.244, and 0.266 dL/g in 0.1 N NaCl. It should be noted that CPE and PZ have similar [η] (0.101 vs. 0.114 dL/g) in 0.1 N NaCl, while the DAPE and ZAPE derived from PZ have twice the [η] values of the corresponding polymers derived from CPE, as shown in FIG. 5, as confirmed by the higher Mw of DAPE derived from PZ. This indicates that even though PZ has higher molar mass than that of CPE, they have similar [η] values as a result of the former having zwitterionic groups that leads to contraction of the polymer chains.

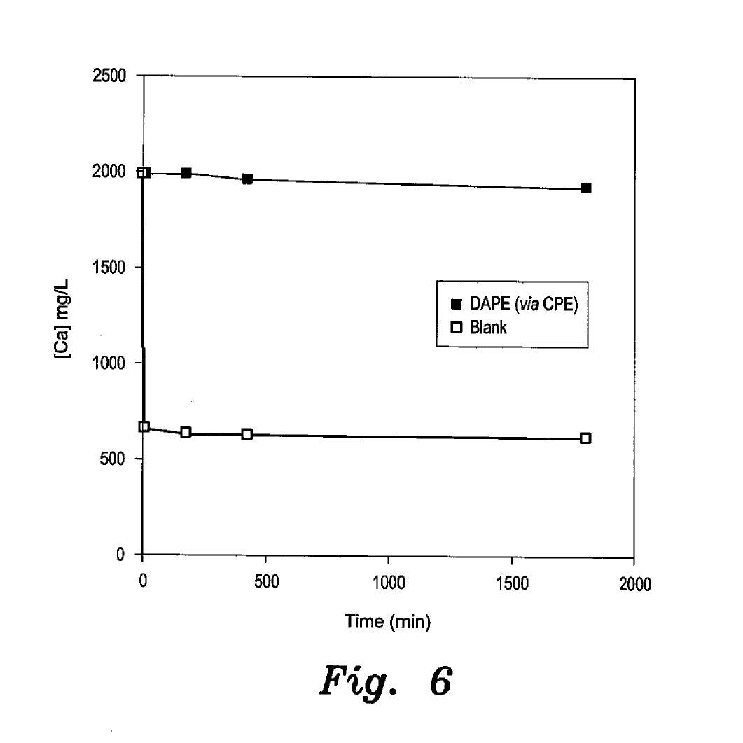

In the reverse osmosis (RO) process, the feed water splits into product water and reject brine streams. The dissolved salts in the feed water are concentrated in the reject brine stream. If supersaturation occurs and their solubility limits are exceeded, precipitation or scaling will occur. Scale inhibition is calculated as:

$$\% Scale Inhibition = \frac{{[ {Ca}^{2 +} ]}_{inhibited ( t )} - {[ {Ca}^{2 +} ]}_{blank ( t )}}{{[ {Ca}^{2 +} ]}_{inhibited ( {t}_{0} )} - {[ {Ca}^{2 +} ]}_{blank ( t )}} \times 100 ,$$

where [Ca²⁺]_{inhibited (t}_{₀}₎ is the initial concentration at time zero, and [Ca²⁺]_{inhibited(t)} and [Ca²⁺]_{blank(t)} are the concentration in the inhibited and blank solutions at time t, respectively. The blank at the zero time was a supersaturated solution of CaSO₄ containing 1993 mg/L Ca²⁺ (using CaCl₂) and 4830 mg/L SO₄²⁻ (using Na₂SO₄), which is equivalent to 2.3 times the concentration of a concentrated brine (CB). Spontaneous precipitation of CaSO₄ was observed in the case of the blank solution, with the decrease in the concentration of Ca²⁺, as shown above in Table 1 and in FIG. 6. However, with the addition of DAPE to the concentrated brine solution, [Ca²⁺] remained almost constant for about 180 minutes with 99.6% scale inhibition. After the lapse of 30 hours, [Ca²⁺] dropped from 1990 mg/L to 1930 mg/L, resulting in a scale inhibition of 95.6%. This indicates that the additive is very effective against precipitation of CaSO₄ at 50° C. in a 2.3 CB, and thus is suitable for its application in the prevention of scaling in RO desalination plants. ICP OES analysis of total phosphorus showed that DAPE has about 10 times less phosphorus than commercially available antiscalants used in RO plants.

It is to be understood that the present invention is not limited to the embodiments described above, but encompasses any and all embodiments within the scope of the following claims.

We claim:

1. An antiscalant compound, comprising poly[disodium 3-(N,N-diallylamino)propanephosphonate].

2. A method of making an antiscalant compound, comprising the steps of:
bubbling HCl gas into an ice-cooled solution of N,N-diallyl-3-(diethylphosphonato)propylamine to obtain a cationic monomer, N,N-diallyl-3-(diethylphosphonato)propylammonium chloride;
cyclopolymerizing the cationic monomer in aqueous solution to obtain a cationic polyelectrolyte, polydiallyl-(diethylphosphonato)propylammonium chloride;
hydrolyzing the cationic polyelectrolyte in acid solution to produce a polyzwitterion acid, poly[3-(N,N-diallylammonio)propanephosphonic acid; and
reacting the polyzwitterion acid with 2 equivalents of sodium hydroxide to produce the antiscalant compound, poly[disodium 3-(N,N-diallylamino)propanephosphonate].

3. The method of making an antiscalant compound as recited in claim 2, wherein the step of cyclopolymerizing the cationic monomer comprises the step of initiating polymerization with tert-butyl hydroperoxide (TBHP).

4. A method of preventing calcium sulphate scale formation in reverse osmosis plants, comprising the step of treating feed water in a reverse osmosis plant with poly[disodium 3-(N,N-diallylamino)propanephosphonate].
